(19) United States
(12) Patent Application Publication
(10) Pub. No.: US 2026/0161896 A1
(43) Pub. Date: Jun. 11, 2026

(54) INFORMATION PROCESSING APPARATUS

(71) Applicant: TOYOTA JIDOSHA KABUSHIKI KAISHA, Toyota-shi (JP)

(72) Inventor: Masayuki OKAMOTO, Nagoya-shi (JP)

(73) Assignee: TOYOTA JIDOSHA KABUSHIKI KAISHA, Toyota-shi (JP)

(21) Appl. No.: 19/390,863

(22) Filed: Nov. 17, 2025

(30) Foreign Application Priority Data
Dec. 5, 2024 (JP) 2024-212137

(51) Int. Cl. G06F 40/35

(52) U.S. Cl. CPC G06F 40/35

(57) ABSTRACT

An information processing apparatus includes a controller configured to, when having a chat using a language model to extract know-how from a user, determine whether a question to the user in the chat contains content related to acquired know-how that has been acquired in a previous chat, and when the question contains the content related to the acquired know-how, display a provider of the acquired know-how along with the question.

### CROSS-REFERENCE TO RELATED APPLICATION

This application claims priority to Japanese Patent Application No. 2024-212137 filed on Dec. 5, 2024, the entire contents of which are incorporated herein by reference.

### TECHNICAL FIELD

The present disclosure relates to an information processing apparatus.

### BACKGROUND

Technology related to learning systems for knowledge, know-how, and the like has been known. For example, Patent Literature (PTL) 1 discloses creating second-level script data based on first-level script data, and outputting a lecture that includes audio vocalizing text data of the second-level script data and video of an avatar instructor.

### CITATION LIST

### Patent Literature

PTL 1: JP 7473270 B1

### SUMMARY

PTL 1 discloses a learning system utilizing machine learning such as generative AI. However, PTL 1 does not consider effectively utilizing previously acquired know-how when extracting know-how from experts such as veterans.

It would be helpful to effectively utilize previously acquired know-how when extracting know-how from experts such as veterans.

An information processing apparatus according to the present disclosure includes a controller configured to:
when having a chat using a language model to extract know-how from a user, determine whether a question to the user in the chat contains content related to acquired know-how that has been acquired in a previous chat; and
when the question contains the content related to the acquired know-how, display a provider of the acquired know-how along with the question.

According to the present disclosure, it is possible to effectively utilize previously acquired know-how when extracting know-how from experts such as veterans.

### BRIEF DESCRIPTION OF THE DRAWINGS

In the accompanying drawings:

FIG. 1 is a diagram illustrating a configuration of an information processing system according to an embodiment of the present disclosure; and

FIG. 2 is a flowchart illustrating operations of the information processing system according to the embodiment of the present disclosure.

### DETAILED DESCRIPTION

An embodiment of the present disclosure will be described below with reference to the drawings.

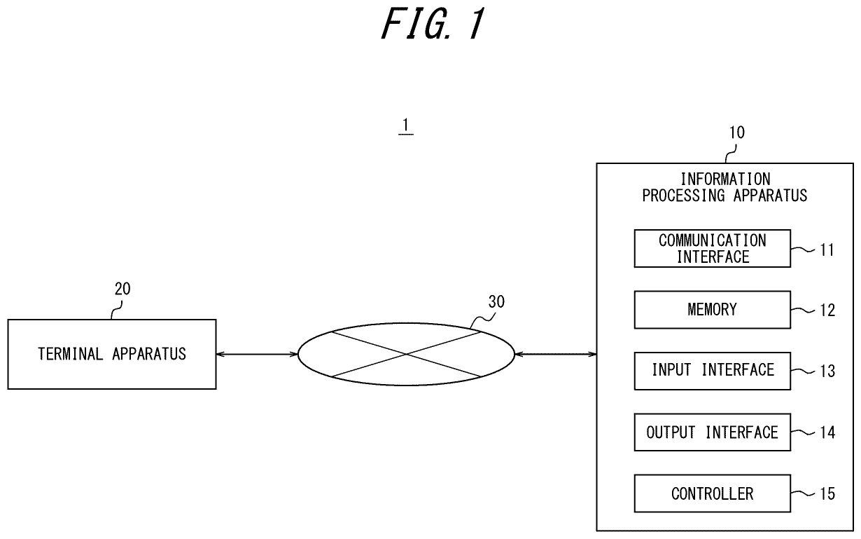

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and a terminal apparatus 20. The information processing apparatus 10 and the terminal apparatus 20 are communicably connected via a network 30.

The information processing apparatus 10 is, for example, a server apparatus. The information processing apparatus 10 is equipped with a language model. In the present embodiment, the language model includes any dialogue system such as a Large Language Model (LLM) or a chatbot. The information processing apparatus 10 can execute a chat to extract know-how from the user using the language model. For example, the information processing apparatus 10 can output questions to the user via the terminal apparatus 20. Also, for example, the information processing apparatus 10 can obtain the user's answers to the questions via the terminal apparatus 20.

The terminal apparatus 20 is any apparatus used by the user. The terminal apparatus 20 is, for example, a general purpose electronic device such as a smartphone, tablet, wearable device, or personal computer (PC), or a dedicated electronic device.

First, an outline of the present embodiment will be described, and details thereof will be described later. The information processing apparatus 10 can execute a chat to extract know-how from the user. The information processing apparatus 10 can execute a chat using the language model.

Here, know-how refers to specific or specialized knowledge, skills, techniques, or information. For example, the application targets of know-how include tasks such as screwing or assembly, operation of applications or software, or procedures for business execution.

The information processing apparatus 10 executes a chat to extract know-how from the user. The user may be a veteran who possesses various knowledge and information. When executing a chat to extract know-how from the user, the information processing apparatus 10 determines whether the questions posed to the user in the chat include content related to the know-how obtained in previous chats. If the questions posed to the user in the chat include content related to the know-how obtained in previous chats, the information processing apparatus 10 displays the provider of the know-how obtained in the previous chat along with the question.

The device operated by the user when executing the chat is the terminal apparatus 20. Therefore, when executing a chat to extract know-how from the user, the information processing apparatus 10 displays the chat screen via the terminal apparatus 20.

As illustrated in FIG. 1, the information processing apparatus 10 includes a communication interface 11, a memory 12, an input interface 13, an output interface 14, and a controller 15.

The communication interface 11 includes at least one external communication interface. The interface for communication may be either a wired or wireless communication interface. In the case of wired communication, the communication interface is, for example, a Local Area Network (LAN). In the case of wireless communication, the communication interface is, for example, an interface compatible with mobile communication standards such as 5G, or an interface compatible with short-range wireless communication. The communication interface 11 receives data to be used for operations of the information processing apparatus 10, and transmits data obtained by operations of the information processing apparatus 10. The memory 12 includes at least one semiconductor memory, magnetic memory, or optical memory. The memory 12 functions, for example, as a main storage device or auxiliary storage device. The memory 12 stores data to be used in the operations of the information processing apparatus 10 and data obtained by the operations of the information processing apparatus 10. The input interface 13 includes at least one interface for input. The interface for input may be, for example, a physical key, a touch screen, an audio sensor that accepts audio input, or a camera that accepts gesture input. The input interface 13 accepts an operation for inputting data to be used for the operations of the information processing apparatus 10. The output interface 14 includes at least one interface for output. The interface for output is, for example, a display for outputting information in the form of images, or a speaker for outputting information in the form of audio. The output interface 14 outputs data obtained by operations of the information processing apparatus 10. The controller 15 includes at least one processor. The processor is, for example, a general purpose processor such as a central processing unit (CPU), or a dedicated processor dedicated to specific processing. The controller 15 executes processes related to the operations of the information processing apparatus 10 while controlling components of the information processing apparatus 10.

The functions of the information processing apparatus 10 are realized by execution of a program according to the present embodiment by a processor corresponding to the controller 15. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10. In the present embodiment, the program can be recorded on a computer readable recording medium. The computer readable recording medium includes a non-transitory computer readable medium and is, for example, a magnetic recording apparatus or a semiconductor memory. The program is distributed, for example, by selling, transferring, or lending a portable recording medium such as a DVD on which the program is recorded. The program may also be distributed by storing the program in a storage of an external server and transmitting the program from the external server to another computer. The program may be provided as a program product. Some or all of the functions of the information processing apparatus 10 may be realized by a dedicated circuit corresponding to the controller 15. That is, some or all of the functions of the information processing apparatus 10 may be realized by hardware.

### Operations of Information Processing System

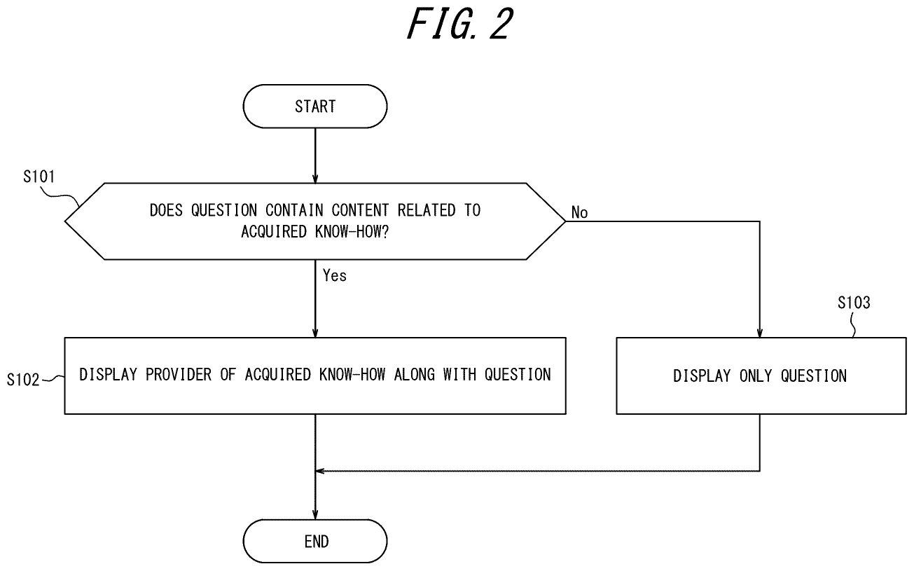

Operations of the information processing system 1 are described with reference to the flowchart in FIG. 2.

S101: The controller 15 of the information processing apparatus 10 determines whether the questions to the user in the chat executed to extract know-how from the user include content related to the know-how acquired in previous chats. Hereafter, the “know-how acquired in previous chats” may simply be referred to as “acquired know-how.” The previous chats may be those of the user currently chatting or those of other users.

The user is a veteran who possesses various knowledge and information about the know-how they are trying to extract. The memory unit 12 stores the language model. The language model may be, for example, a Large Language Model (LLM). The controller 15 can execute a chat to extract know-how from the user using the language model stored in the memory unit 12. When executing the chat, the controller 15 may conduct the chat in text or in voice.

If it is determined as Yes in S101, the controller 15 proceeds to S102. If it is determined as No in S101, the controller 15 proceeds to S103.

S102: If the question posed to the user in the chat includes content related to the acquired know-how, the controller 15 of the information processing apparatus 10 displays the provider of the acquired know-how along with the question. For example, if the question includes content related to the know-how acquired from user A, it may display along with the question, “User A said this,” thereby showing user A as the provider of the know-how. This allows the information processing apparatus 10 to ask the user a question while indicating that the question includes content related to the acquired know-how and who the provider of the acquired know-how is, effectively utilizing previously acquired know-how.

The controller 15 may obtain approval/disapproval information regarding whether the current user answering the question is in favor of or against the acquired know-how, which includes content related to the question. For example, the controller 15 may obtain approval/disapproval information based on the current user's response to the question. For example, if the user's response to the question does not include negative content and the chat continues, it may be determined that the user is in favor of the acquired know-how. For example, if the user's response to the question includes negative content, it may be determined that the user is against the acquired know-how. For example, the controller 15 may ask a question about whether the user is in favor of or against the acquired know-how and obtain approval/disapproval information based on the response to that question. Alternatively, the controller 15 may obtain an image of the user captured by a camera, analyze the obtained image to determine the user's expression, and thereby determine whether the user is in favor of or against the acquired know-how.

When obtaining approval/disapproval information regarding the acquired know-how, the controller 15 associates the approval/disapproval information with the acquired know-how and stores it in the memory unit 12. For example, the controller 15 may associate one acquired know-how with the provider being user A, user B being in favor, and user C being against, and store this in the memory unit 12. Based on the approval/disapproval information, the controller 15 may calculate the reliability of the acquired know-how. Reliability may be, for example, the ratio of users who are in favor of the acquired know-how.

The controller 15 may display, along with the question, the provider of the acquired know-how and approval/disapproval information if the question to the user in the chat contains content related to the acquired know-how. For example, the controller 15 may display, along with the question, “User A said this. User B agrees with this content. User C opposes this content,” and so on. This allows the user to chat while confirming what kind of approval or disapproval exists regarding the acquired know-how.

S103: If the question to the user in the chat does not contain content related to the acquired know-how, the controller 15 of the information processing apparatus 10 displays only the question.

As described above, in the information processing apparatus 10 according to the present embodiment, the controller 15 determines whether the question to the user in the chat contains content related to the acquired know-how that has been acquired in a previous chat when executing a chat to extract know-how from the user using a language model; and if the question contains content related to the acquired know-how, displays a provider of the acquired know-how along with the question. This allows the information processing apparatus 10 according to the present embodiment to ask the user questions while indicating that the question contains content related to the acquired know-how and who the provider of the acquired know-how is. Therefore, the information processing apparatus 10 according to the present embodiment can effectively utilize previously acquired know-how when extracting know-how from experts such as veterans.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the terminal apparatus 20. Also, some of the processing operations executed in the terminal apparatus 20 in the above embodiment may be executed in the information processing apparatus 10.

1. An information processing apparatus comprising a controller configured to:
when having a chat using a language model to extract know-how from a user, determine whether a question to the user in the chat contains content related to acquired know-how that has been acquired in a previous chat; and
when the question contains the content related to the acquired know-how, display a provider of the acquired know-how along with the question.

2. The information processing apparatus according to claim 1, wherein the controller is configured to acquire approval/disapproval information regarding whether the user who is currently answering the question containing the content related to the acquired know-how approves or disapproves of the acquired know-how.

3. The information processing apparatus according to claim 2, wherein the controller is configured to acquire the approval/disapproval information based on content of a response of the user to the question.

4. The information processing apparatus according to claim 2, further comprising a memory,
wherein the controller is configured to, upon acquiring the approval/disapproval information, store, in the memory, the approval/disapproval information with associating the approval/disapproval information with the acquired know-how.

5. The information processing apparatus according to claim 4, wherein the controller is configured to display the provider of the acquired know-how and the approval/disapproval information, along with the question, when the question contains the content related to the acquired know-how.
